(19) United States
(12) Patent Application Publication
(10) Pub. No.: US 2025/0163232 A1
(43) Pub. Date: May 22, 2025

(54) SUBSTANCE, MEMBRANE, USE OF A MEMBRANE AND METHOD FOR THE PREPARATION OF A SUBSTANCE

(71) Applicant: Forschungszentrum Jülich GmbH, Jülich (DE)

(72) Inventors: Sebastian AUFFARTH, Nürnberg (DE); Jochen KERRES, Bubenreuth (DE); Philipp MARTSCHIN, Wörth am Main (DE); Theresa STIGLER, Nürnberg (DE); Julian STONAWSKI, Nürnberg (DE); Maximilian WAGNER, Oberthürheim (DE)

(21) Appl. No.: 18/837,770

(22) PCT Filed: Mar. 8, 2023
(86) PCT No.: PCT/EP2023/055865

§ 371 Date: Aug. 12, 2024

(30) Foreign Application Priority Data
Mar. 11, 2022 (DE) 10 2022 105 724.0

(51) Int. Cl. C08J 7/12; B01J 39/05; B01J 39/20; B01J 41/05; B01J 41/13; B01J 47/12; C08J 5/22; C25B 13/08; H01M 8/1023; H01M 8/1027; H01M 8/1032; H01M 8/1039

(52) U.S. Cl. CPC C08J 7/12; B01J 39/05; B01J 39/20; B01J 41/05; B01J 41/13; B01J 47/12; C08J 5/2262; C25B 13/08; H01M 8/1023; H01M 8/1027; H01M 8/1032; H01M 8/1039; C08J 2325/18; C08J 2361/18; C08J 2371/12; C08J 2381/06

(57) ABSTRACT

The present invention relates: to a substance, in particular functionalised oligomer or polymer, wherein the substance contains oligomeric or polymeric chains to which perfluoroaromatic compounds are coupled or which contain perfluoroaromatic compounds; and to a membrane, in particular a blended membrane; and to a method for producing a substance, comprising the following steps: providing a starting substance, which contains oligomeric or polymeric chains to which perfluoroaromatic compounds having a plurality of fluorine atoms are coupled or which contain perfluoroaromatic compounds having a plurality of fluorine atoms; nucelophilic substitution of at least two, in particular of precisely two, three, four or five fluorine atoms of the perfluoroaromatic compound by one functional group in each case.

The present invention relates to a substance, in particular a functionalized oligomer or polymer, wherein the substance contains oligomeric or polymeric chains to which perfluoroaromatic compounds are coupled or which contain perfluoroaromatic compounds. The invention also relates to a membrane containing such a substance and to the use of a membrane. The invention also relates to a method for the production of such a substance.

Membranes, especially ion exchange membranes, are used in particular in electrochemical processes, for example in electrolysis processes, or in electrochemical systems, for example in a fuel cell or in a battery. High demands are placed on such membranes. On the one hand, they must be sufficiently chemically stable in relation to the surrounding medium for their area of application. In addition, such membranes are often exposed to mechanical stresses. Electrochemical applications also require a certain degree of conductivity combined with a low degree of swelling, i.e. low volume expansion.

Oligomers and polymers from which such membranes are produced can contain perfluoroaromatic compounds. These can be coupled to oligomeric or polymeric chains or be part of the chain backbone. It is also possible to attach such perfluoroaromatic compounds to a base material. In order to improve the properties of such an oligomer/polymer, there are various ways of substituting a fluorine atom of a perfluoroaromatic compound with a functional group. Specifically, it is known to nucleophilically substitute the 4-F fluorine atom in poly(pentafluorostyrene) (PPFSt) with different functional groups, also known as nucleophiles.

By Noy-J.M.; Li, Y.; Smolan, W.; roth, P.J. Azide-para-Fluoro Substitution on Polymers: Multipurpose Precursors for Efficient Sequential Postpoylmerization Modification. Marcomolecules 2019, 52, 3083-3091 is known to replace the 4-F atom of polypentafluorostyrene with an NH₂ molecule. A functionalized polymer is produced in two steps starting from polypentafluorostyrene. In the first step, the 4-F atom is replaced by an N₃ molecule. In the second step, this N₃ molecule is converted into an NH₂ molecule. The reaction in the second step is shown in the figure below, where the NH₂-functionalized polymer is shown on the left.

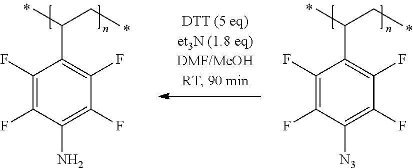

Also Chen, J.; Dumas, L.; Duchet-Rumeau, J.; Fleury, E.; Charlot, A.; Portinha, D. Tuning h-bond capability of hydroxylated-poly(2,3,4,5,6-pentaluorostyrene) grafted copolymers prepared by chemeselective and versatile thiol-para-fluoro “click-type” coupling with mercapatoalcohols. J. Polym. Sci. A. Polym. Chem. 2012, 50, 3452-3640 report a simple nucleophilic substitution of the 4-F atom. In this case, a functional group is coupled to the perfluoroaromatic compound in such a way that a fluorine atom is substituted by a mercaptothiol group. The structure of the resulting substance is shown below.

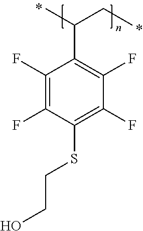

Another simple nucleophilic substitution of a fluorine atom is reported by Sych, G.; Simokaitiene, J.; lygaitis, R.; Jatautiene, E.; Pahsazadeh, R.; Buika, G.; Grazulevicius, J.V. Structure-properties relationship of tetrafluorostyrene-based monomers and polymers containing different donor moieties. Reactive and Functional Polymers 2019, 143, 104323. In this case, a nitrogen atom takes the position of a fluorine atom of the perfluoroaromatic compound. The structure is shown in the figure below.

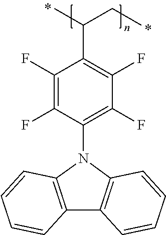

DE 10 2019 008 024 A1 discloses further nucleophilic substitutions of perfluoroaromatic compounds of oligomers or polymers. Specifically, a nitrogen atom takes the place of the fluorine atom on the perfluoroaromatic compound. The structure finally obtained is shown below.

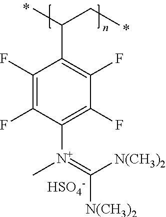

Further simple nucleophilic substitutions are described in

Sych, G.; Simokaitiene, J.; lygaitis, R.; Jatautiene, E.; Pahsazadeh, R.; Buika, G.; Grazulevicius, J.V. Structure-properties relationship of tetrafluorostyrene-based monomers and polymers containing different donor moieties. Reactive and Functional Polymers 2019, 143, 104323;

Cho, H.; Atanasov, V.; Krieg, H.M.; Kerres, J.A. Novel Anion Exchange Membrane Based on Poly(Pentafluorostyrene) Substituted with Mercaptotetrazole Pendant Groups and its Blend with Polybenzimidazole for Vanadium Redox Flow Battery Applications. Polymers (Basel) 2020, 12;

Atanasov, V.; Burger, M.; Lyonnard, S.; Porcar, L.; Kerres, J. Sulfonated poly(pentafluorostyrene): Synthesis & characterization. Solid State Ionics 2013, 252, 75-83; and

Atanasov, V.; Kerres, J. Highly Phosphonated Polypentafluorostyrene. Macromolecules 2011, 44, 6416-6423.

Such polymers can be provided with a functional group. However, this makes it difficult to achieve certain property profiles. For example, polypentafluorostyrene, whose 4-F atom is substituted with phosphonic acid groups, has a very high brittleness. This makes it impossible to use this material as a membrane in a fuel cell. The mechanical properties can be improved, for example by converting it into an acid-base blend with a mechanically and chemically stable basic polymer such as polybenzimidazole (PBI). However, this conversion reduces the number of free phosphonic acid groups due to ionic cross-linking between the acidic phosphonic acid groups and the basic imidazole groups of the PBI. This leads to a reduction in ionic conductivity, which is undesirable.

The object of the present invention is therefore to provide a substance which has favorable property profiles and can be used in particular in membranes for electrochemical processes. Furthermore, a process for the production of such a substance is to be created.

This object is solved in a substance of the type mentioned at the beginning in that several, in particular two, three, four or five fluorine atoms of the perfluoroaromatic compound are each nucleophilically substituted by a functional group.

Accordingly, the method according to the invention for producing such a substance comprises the following steps:
providing a starting material which contains oligomeric or polymeric chains to which perfluoroaromatic compounds with several fluorine atoms are coupled or which contain perfluoroaromatic compounds with several fluorine atoms;
nucleophilic substitution of at least one or more, in particular of exactly two, three, four or five fluorine atoms of the perfluoroaromatic compound by one functional group in each case.

The invention is thus based on the idea of using the perfluoroaromatic compounds in a starting material to substitute not just one fluorine atom, but several fluorine atoms with functional groups. In other words, functional groups take the place of fluorine atoms. As a result, the property profile can be adapted to the application and different properties can be specifically combined with each other. For example, it is possible to create a polymer with a high ionic conductivity that also has a low brittleness so that it can be used as a membrane in an electrochemical application, for example in a fuel cell, an electrolysis or a redox-flow battery. The material can be an intermediate product, particularly in the manufacture of a membrane.

Specifically, the perfluoroaromatic compound can be or comprise a perfluorophenyl and/or a perfluorobiphenyl unit. A perfluorophenyl unit or a perfluorobiphenyl unit is usually docked to an oligomeric or polymeric backbone and basically comprises several fluorine atoms, in special applications 4 or 8 fluorine atoms. In principle, the perfluoroaromatic compound can also be a perfluoroterphenyl unit or a quaterphenyl unit.

Preferably, the para position and at least one ortho position and/or at least one meta position of the perfluorophenyl unit or the perfluorobiphenyl unit or a perfluoroterphenyl unit or quaterphenyl unit are each substituted by a functional group. It follows from the previously known prior art that a functional group has a tendency to first substitute the para position on the perfluorophenyl unit or the perfluorobiphenyl unit. Therefore, if several functional groups are provided on a perfluoroaromatic compound, the fluorine atom on the para position will certainly be substituted first. A further functional group will then be coupled at an ortho position and/or a meta position. If three fluorine atoms are each substituted by a functional group, an ortho fluorine atom and the meta fluorine atom opposite it can be substituted in addition to the para fluorine atom.

The perfluoroaromatic compound may be contained in the main and/or side chain of the oligomeric or polymeric chain or form a side chain. In other words, a perfluoroaromatic compound may be contained in the backbone or coupled to it. Thus, the incorporation of perfluoroaromatic compounds into the main and/or side chain of the polymer molecule enables subsequent multiple functionalization of the polymer.

In a further embodiment, the oligomeric or polymeric chains may contain cation exchangers and/or anion exchanger groups. Furthermore, the oligomeric or polymeric chains may contain a repeating unit comprising or consisting of pentafluorostyrene.

In a further embodiment, the multiple fluorine atoms of the perfluoroaromatic compound may be substituted with the same functional group or with different functional groups. In other words, the same functional group can replace several fluorine atoms of the perfluoroaromatic compound. Alternatively, different functional groups can also be provided, which can be advantageous in particular for adjusting different material properties.

Specifically, a functional group can be coupled to the perfluoroaromatic compound in such a way that a fluorine atom is substituted via a sulphur atom. In other words, the functional group can be designed in such a way that a sulphur atom takes the place of a fluorine atom of the perfluoroaromatic compound. For example, a molecule with a thiol group can be used for substitution. Such a thiol group, which is also called a sulfhydryl group, is in principle a functional group that is similar in structure to the hydroxyl group (—OH), although the oxygen atom is replaced by a sulfur atom. As the sulphur atom is particularly nucleophilic, it can substitute for the fluorine atom. If a thiol group is introduced into an organic compound, as is the case with the nucleophilic substitution described above, this is referred to as thiolation or thiolation. In this case, the sulphur atom of the thiol group takes the place of a fluorine atom of the perfluoroaromatic compound.

In a further embodiment, a functional group can have a linear and/or branched saturated or unsaturated Cₙ-body, in particular a C₂-, C₃-, C₆-, C₈-, C₁₀-, C₁₂-, C₁₄-, C₁₆- or a C₁₈-body, which carries at one end the sulphur atom which substitutes a fluorine atom of the perfluoroaromatic compound. In other words, the sulphur atom substituting the fluorine atom is followed by a corresponding linear or branched Cₙ-body, which may also contain double bonds that can potentially be used for further addition or substitution reactions, for example for crosslinking. At the other end of the Cₙ body, a quinuclidinium group or another quaternary N group, in particular an ammonium, imidazolium, benzimidazolium, piperidinium, piperazinium, guanidinium, pyridinium group, preferably with counterions, can be attached, in particular with a bis(trifluoromethylsulfonyl)amide anion or a mineral acid anion, in particular a halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃⁻, phosphonate R—PO H₃⁻, carbonate CO₃²⁻, HCO₃⁻, or with an organic carboxylic acid anion, in particular CH₃ COO⁻, HCOO⁻. In other words, any other quaternary ammonium group NR₄⁺ with R=any alkyl and/or aryl, for example a piperidinium or piperazinium or imidazolium group, benzimidazolium group, pyridinium group, alkylguanidinium group, in particular with a counter anion, can be attached to the other end of the Cₙ body, in particular mineral acid anions (including halides, sulphates, sulphites, phosphates, carbonates, (per) chlorates, borates), as well as organic counteranions (including bis(sulphonyl)imides, carboxylic acid derivatives, sulphonic acid derivatives, phosphonic acid derivatives). Such Cₙ-bodies can have a chain-like structure and are then also referred to as Cₙ-chains.

In addition, the functional group may contain a nitrogen atom as a primary, secondary, tertiary or quaternary amine or ammonium group. Such a nitrogen atom can, for example, be provided within a linear or branched Cₙ-body which may contain unsaturated groups.

A functional group can be in the form R—SH, R—S⁻, R—OH, R—NH, R—N⁻ or PO R₃₂, where R is an alkyl radical, aryl radical, alkyl, aryl, a metal, Si(CH)₃₃ or H.

Any form of combination is conceivable. Specifically, the first nucleophile, i.e. the first functional group that substitutes the para-fluorine atom, can have the form R—SH, R—S⁻, R—OH, R—O⁻, R—NH₂, R—NH, R—N⁻, or PO R₃₂. Completely independently of this, a second functional group can comprise all forms. The same applies to a third functional group.

It is thus possible that in the case of perfluoroaromatic compounds on which a fluorine atom (for example the 4-F atom in a pentafluorophenyl unit) has already been replaced by one of the aforementioned functional groups, in particular of the form R—SH, by means of a nucleophilic substitution reaction, R—S⁻, R—OH, R—O⁻, R—NH₂, R—NH, R—N⁻, or PO R₃₂, subsequently, by means of further nucleophilic substitution reactions, further fluorine atoms are substituted by the same or another functional group, in particular of the form R—SH, R—S⁻, R—OH, R—O⁻, R—NH₂, R—NH, R—N⁻, or PO R₃₂.

The remainder R may differ for the various functional groups. It is thus readily possible for the first functional group to have the form R—SH, where R is aryl, and for the second functional group to have the form R—OH, where R is a metal. Furthermore, the third functional group can readily have a further form, for example R—NH, where R is alkyl.

A functional group may also contain a thiol group or be based on a thiol group or have been prepared from a thiol group.

If the functional group has the form S—R, with the sulfur atom taking the position of the substituted fluorine atom, the radical R can be formed as shown in the figure below, but this does not limit the types of possible radicals R.

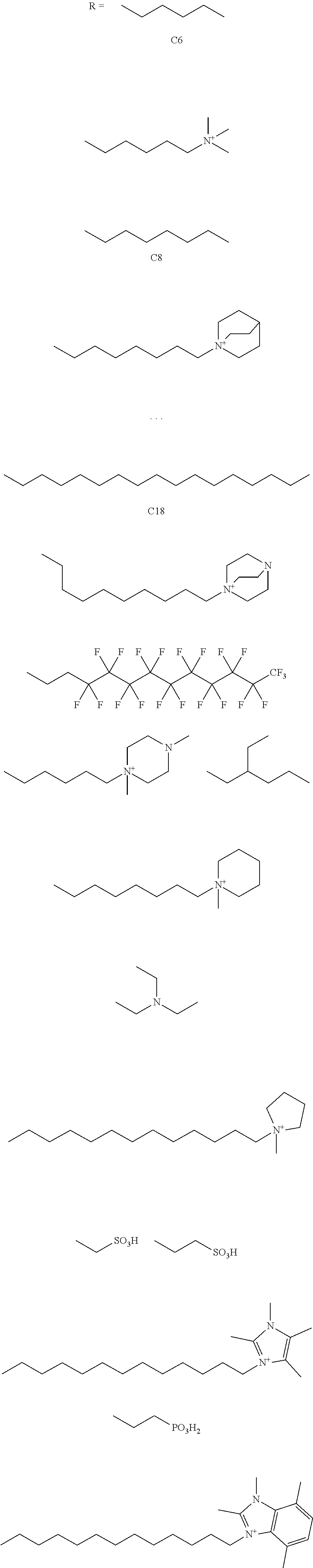

Furthermore, a functional group may contain SO₃ with a counter cation, in particular with a metal counter cation or with an ammonium counter cation in the form NR₄⁺ with R═H, alkyl, aryl or with another N-basic cation, in particular imidazolium, benzimidazolium, guanidinium. A functional group may contain C NH₅₁₀, where the nitrogen atom substitutes the fluorine atom of the perfluoroaromatic compound. In particular, a residue or counter anion can be coupled via the nitrogen atom. counter anion can be coupled via the nitrogen atom, the radical preferably being a halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃⁻, phosphonate R—PO H₃⁻, carbonate CO₃²⁻, HCO₃⁻ or an organic carboxylic acid anion such as CH₃ COO⁻, HCOO⁻. The residue or the counter anion may in particular be mineral acid anions (including halides, sulphates, sulphites, phosphates, carbonates, (per) chlorates, borates), or organic counter anions, preferably bis(sulphonyl)imides, carboxylic acid derivatives, sulphonic acid derivatives, phosphonic acid derivatives).

It may be provided that the functional group is coupled to several, in particular to two perfluoroaromatic compounds of two organic oligomeric or polymeric chains, so that the functional group cross-links the chains with one another. This embodiment is based on the idea of not functionalizing the oligomeric or polymeric chains independently of one another, but functionalizing them in such a way that they are additionally crosslinked with one another. This can influence the mechanical properties of the substance in particular.

The chains to be cross-linked can be identical oligomeric or polymeric chains or different chains.

In a specific embodiment, such a functional group can be chain-like and have a sulphur atom at each end, which nucleophilically substitutes a fluorine atom of the perfluoroaromatic compounds. Between the two sulphur atoms, the functional group may contain one or more Cₙ-bodies and/or a repeating unit.

The problem underlying the invention is further solved by a membrane, in particular a diaphragm membrane, which contains a substance as described above. In a further embodiment, the membrane may be an ion exchange membrane, preferably a cation exchange membrane or an anion exchange membrane.

A further object of the invention is the use of such a membrane in an electrochemical system, in particular in a fuel cell, preferably a hydrogen fuel cell or a direct fuel cell, or in a battery, in particular in a redox flow battery, or in an electrochemical process, in particular in an electrolysis process, in particular in an acidic or alkaline or bipolar membrane electrolysis. Furthermore, such a membrane can be used as an ion-conducting membrane in electrosynthesis applications.

The method according to the invention can be designed in that the perfluoroaromatic compound of the starting material is a perfluorophenyl or a perfluorobiphenyl unit or comprises such a unit. In the nucleophilic substitution, the para and at least one ortho position and/or at least one meta position of the perfluorophenyl unit or the perfluorobiphenyl unit is preferably substituted by a functional group. In principle, the perfluoroaromatic compound can also be a perfluoroterphenyl unit or a quaterphenyl unit.

Examples of raw materials that can be used are shown in the figure below.

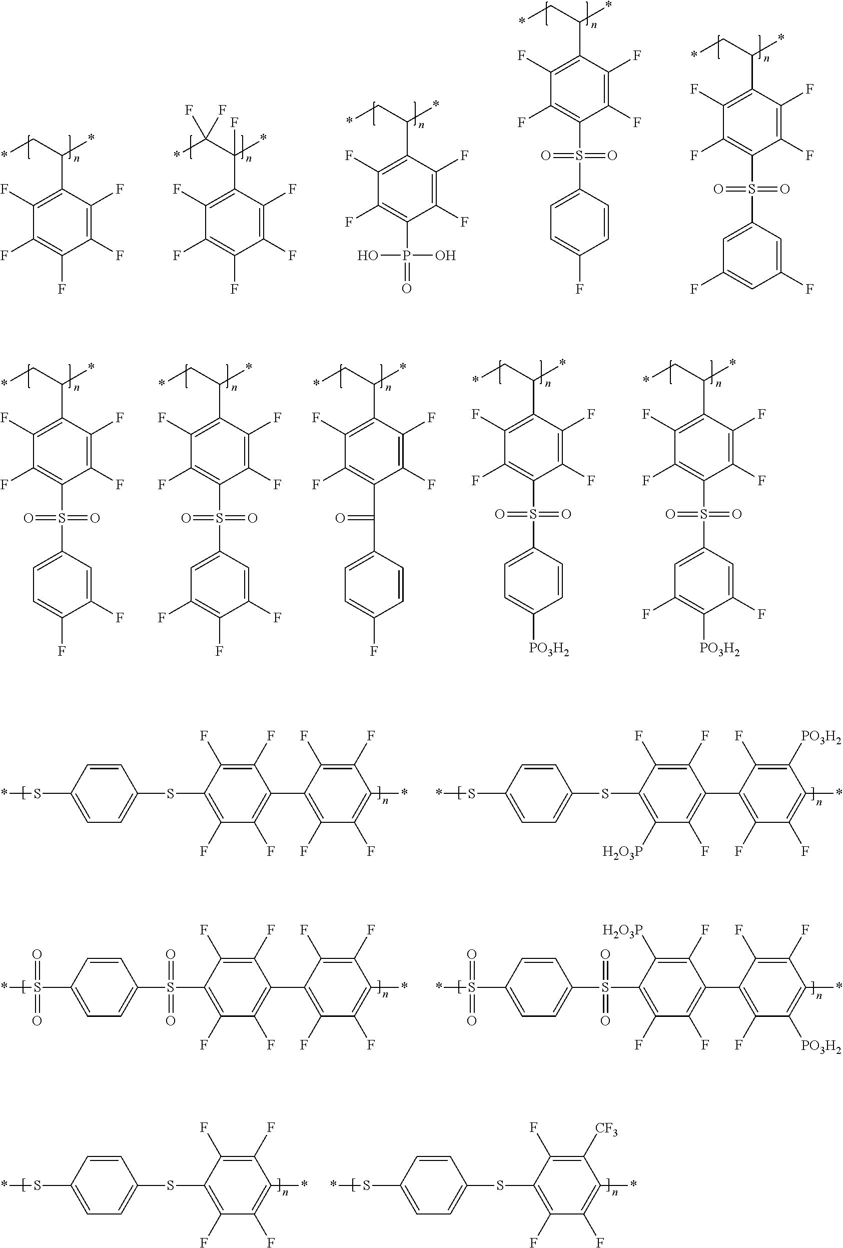

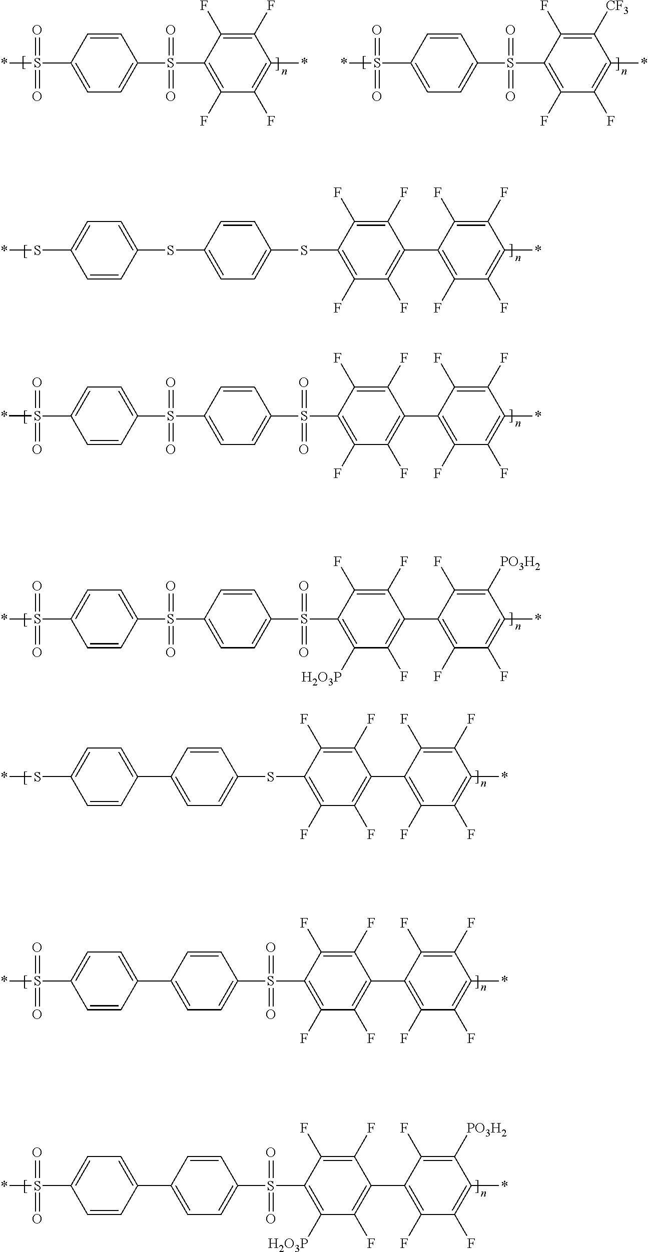

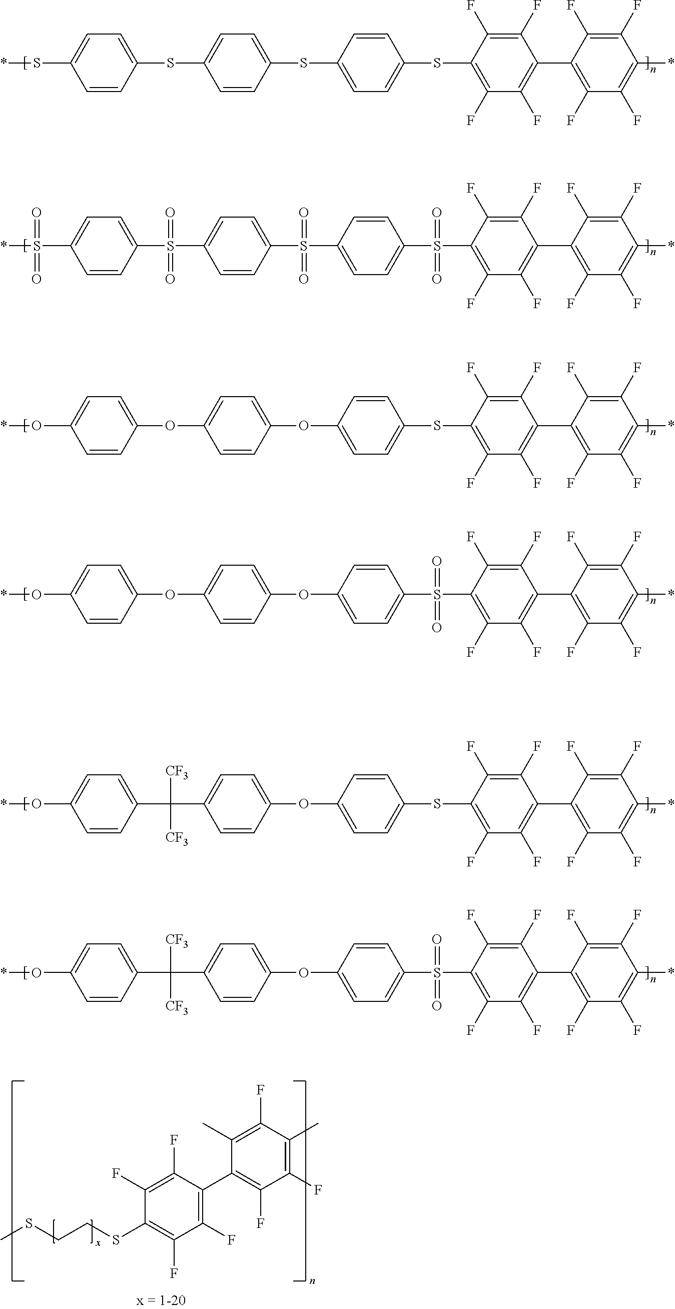

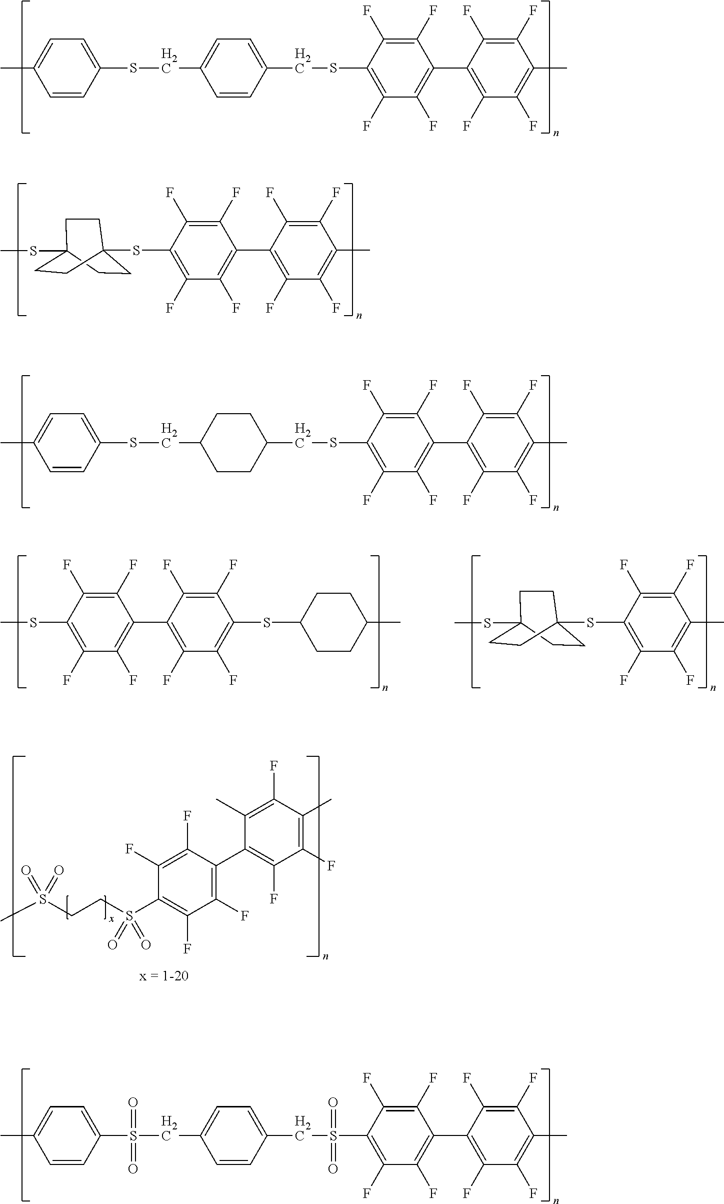

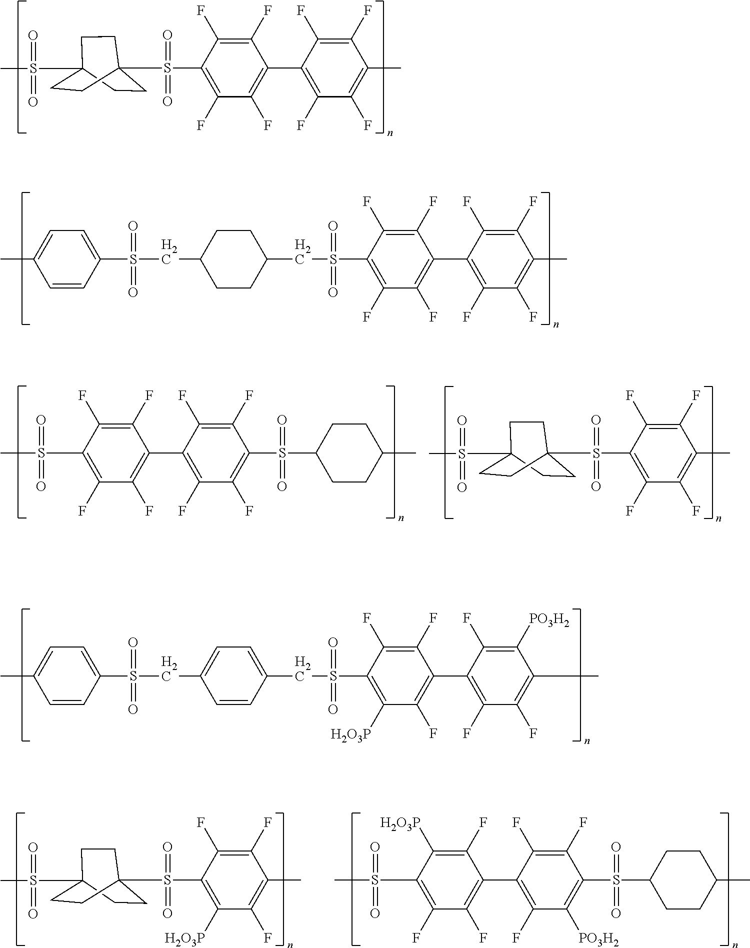

Each of the starting materials shown has perfluoroaromatic compounds/assemblies with several fluorine atoms on which nucleophilic substitution reactions can take place. This means that several fluorine atoms can be substituted by functional groups.

The starting material can also be a partially fluorinated polyether or polythioether or polysulfone or a sulfonated, partially fluorinated or a phosphonated partially fluorinated polymer. Furthermore, the starting material can be a polymer of o-, m- or p-terphenyl or o-, m- or p-quaterphenyl and/or perfluoroacetophenone or another (partially) aromatic and partially or perfluorinated ketone.

The starting material may also be characterized in that it contains fluorinated and/or unfluorinated alkaline spacers in the oligomeric or polymeric chains, in particular in the backbone (in the main polymer chain).

Alternatively, the starting material can be a terphenyl polymer or a quaterphenyl polymer, in particular of angled terphenyl and/or quaterphenyl monomers. The chains of the starting material may contain partially fluorinated terphenyl and/or quaterphenyl units. Furthermore, the starting material may contain fluorene-based backbones.

According to one embodiment of the method according to the invention, the starting material can be prepared by coupling perfluoroaromatic compounds to a base material, in particular to a polymer. In other words, a base material can be used to which perfluoroaromatic compounds, in particular perfluorophenyl units or perfluorobiphenyl units, are specifically coupled. The perfluoroaromatic compound, in particular a perfluorophenyl unit or a perfluorobiphenyl unit, can be coupled to the base material by Suzuki-C—C coupling, in particular under the action of a perfluoroaromatic and/or partially fluoroaromatic boronic acid.

For example, a halogenated, aromatic polymer can be used as the base material, which is substituted on the aromatic compound in particular with I and/or Br and/or Cl.

The method according to the invention can be characterized in that the nucleophilic substitution of several fluorine atoms of the perfluoroaromatic compound takes place in one step. The nucleophilic substitution can preferably take place under the action of a base.

Alternatively, the nucleophilic substitution of several fluorine atoms can take place in several successive steps. Preferably, the fluorine atom at the para position is substituted first (in the case of a pentafluorophenyl radical) before at least one, in particular exactly one, fluorine atom is substituted at the ortho position. As a result of the substitution of the fluorine atom at the ortho position, a substitution may subsequently take place at the opposite meta position.

The two steps can take place under the same or different ambient conditions. For example, the first step, in which a para-fluorine atom is substituted, can take place at room temperature. It is also conceivable that the first step takes place at a temperature between 60° C. and 100° C., in particular at a temperature of at least 70° C. and/or at most 85° C. The reaction time can vary considerably between a few minutes and several days. The second step, in which at least one further fluorine atom is substituted by a functional group, can take place at a higher temperature than in the first step. In particular, the temperature may be at least 70° C., preferably at least 80° C. The duration of the substitution reaction can also vary between a few minutes and several days.

Any substitution reaction can take place under the influence of other media. This may be a base. Alternatively or additionally, the reaction can take place under the action of acetone, diazabicycloundecene (DBU), dimethylformamide (DMF), dimethylacetamide (DMAc), dimethyl sulfate (DMS), CH₃ I, dimethyl carbonate or mixtures or dilute solutions of these media.

It is also conceivable that, in particular, a first substitution reaction takes place during the evaporation of a solvent, which preferably takes place at a temperature below 150° C.

A molecule with a linear or branched, saturated or unsaturated Cₙ-body, in particular with a C₂-, C₃-, C₆-, C₈-, C₁₀-, C₁₂-, C₁₄-, C₁₆-, or a C₁₈-body, which carries a thiol group at one end, can be used for substitution. Preferably, an S atom of the thiol group then substitutes an F atom of the perfluoroaromatic compound. In other words, a saturated or unsaturated hydrocarbon with a thiol group can be used as a substituent. If an unsaturated hydrocarbon is used, it can be used for a subsequent reaction, in particular for a thiol-ene click reaction.

At its other end, the molecule used for substitution may contain a quinuclidinium group or another quaternary N group, in particular an ammonium, imidazolium, benzimidazolium, piperidinium, piperazinium, guanidinium or pyridinium group, preferably with counterions, in particular with a bis(trifluoromethylsulfonyl)amide anion or a mineral acid anion, in particular a halide (F⁻, Cl⁻, Br⁻, I⁻) or SO₄²⁻, HSO₄⁻, PO₄³⁻, HPO₄²⁻, H₂ PO, SO₄₋₃²⁻, SO H₃⁻, phosphonate R—PO H₃⁻, carbonate CO₃²⁻, HCO₃⁻ or with an organic carboxylic acid anion, in particular CH₃ COO⁻, HCOO⁻. The choice of counterions is not limited to the anions mentioned. Furthermore, the molecule used for substitution may contain a nitrogen atom as a primary, secondary, tertiary or quaternary amine or ammonium group.

For the method according to the invention, a molecule in the form R—SH, R—S⁻, R—OH, R—NH, R—N⁻ or PO R₃₂ can be used for substitution. Furthermore, a thiol with a terminal sulfonate group can be used for substitution. In addition, a molecule C NH₅₁₀ may be used for substitution, wherein the nitrogen atom takes the position of a fluorine atom of the perfluoroaromatic compound. In particular, if the nitrogen atom is positively charged, a radical (counterion) can be coupled via the nitrogen atom in a further embodiment, the radical preferably being a halide (F⁻, Cl⁻, Br⁻, I⁻) or SO₄²⁻, HSO₄⁻, PO₄³⁻, HPO₄², H₂ PO₄⁻, SO₃²⁻, SO H₃⁻, phosphonate R—PO H₃⁻, carbonate CO₃²⁻, HCO₃⁻ or an organic carboxylic acid anion, in particular CH₃ COO⁻, HCOO⁻. In principle, the residue can contain any anion as a counterion, whereby anions such as halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃⁻, phosphonate R—PO H₃⁻, carbonate CO₃²⁻, HCO₃⁻ or an organic carboxylic acid anion such as CH₃ COO⁻, HCOO⁻ are preferred.

If the molecule used for substitution has the form S—R, where the sulphur atom takes or should take the position of the substituted fluorine atom, the radical R can be formed as shown in the figure below.

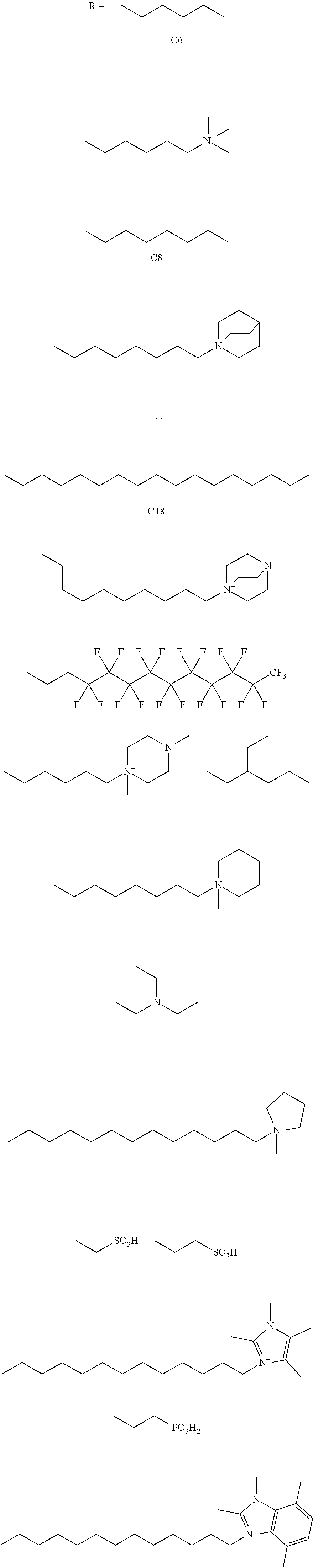

Furthermore, the molecule used for substitution may contain SO₃ with a counter cation, in particular with a metal counter cation or with an ammonium counter cation in the form NR₄⁺ with R═H, alkyl, aryl or with another N-basic cation, in particular imidazolium, benzimidazolium, guanidinium. A functional group may contain C NH₅₁₀, where the nitrogen atom substitutes the fluorine atom of the perfluoroaromatic compound. In particular, the nitrogen atom can be substituted by a radical or counter anion, where the radical is preferably a halide (F⁻, Cl⁻, Br, I⁻) or SO₄²⁻, HSO₄⁻, PO₄³⁻, HPO₄²⁻, H₂ PO₄, SO₃²⁻, SO H₃⁻, phosphonate R—PO H₃⁻, carbonate CO₃²⁻, HCO₃⁻ or an organic carboxylic acid anion such as CH₃ COO⁻, HCOO⁻. The residue or the counter anion may in particular be mineral acid anions (including halides, sulphates, sulphites, phosphates, carbonates, (per) chlorates, borates), or organic counter anions, preferably bis(sulphonyl)imides, carboxylic acid derivatives, sulphonic acid derivatives, phosphonic acid derivatives).

The method according to the invention, in particular the substitution which takes place, can be designed in such a way that the functional group is coupled to several, in particular to two perfluoroaromatic compounds of two organic oligomeric or polymeric chains, so that the functional group cross-links the chains with one another. This embodiment is based on the idea of not functionalizing the oligomeric or polymeric chains independently of one another, but functionalizing them in such a way that they are additionally crosslinked with one another. This can influence the mechanical properties of the substance in particular.

Specifically, the functional group can be chain-like and have a sulphur atom at each end, each of which nucleophilically substitutes a fluorine atom of the perfluoroaromatic compounds. One or more Cₙ-bodies and/or a repeating unit may be contained between the sulphur atoms.

In a further embodiment of the method according to the invention, subsequent reactions for which the functional groups form a reaction basis can take place following the nucleophilic substitution. The residues of the functional groups, which have been coupled to a perfluoroaromatic compound after the substitution has taken place, can be used as a basis for further subsequent reactions. These include the exchange of the counterions of a positively or negatively charged residue of the functional group, a change in the residues of the functional group or the use of an aromatic/unsaturated residue of the functional group.

Specifically, the counterions of a quaternary ammonium salt or an acid group, which are part of the functional group, can be exchanged. Unsaturated residues of the functional group can be used for downstream functionalization or crosslinking of the polymer/oligomer with the perfluoroaromatic compound.

For further embodiments of the invention, reference is made to the subclaims and to the following description of several embodiments with reference to the figures. The figures show:

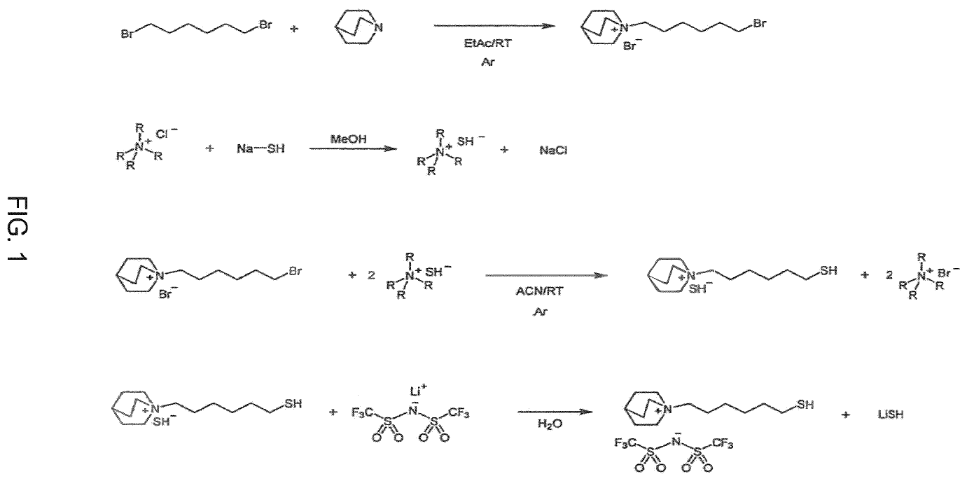

FIG. 1 a reaction scheme for the preparation of a functional group for a substance according to a first embodiment of the present invention;

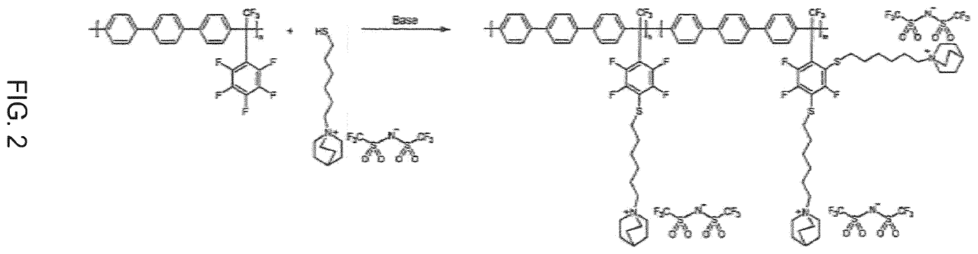

FIG. 2 a reaction scheme of the functional group from FIG. 1 with a polymer;

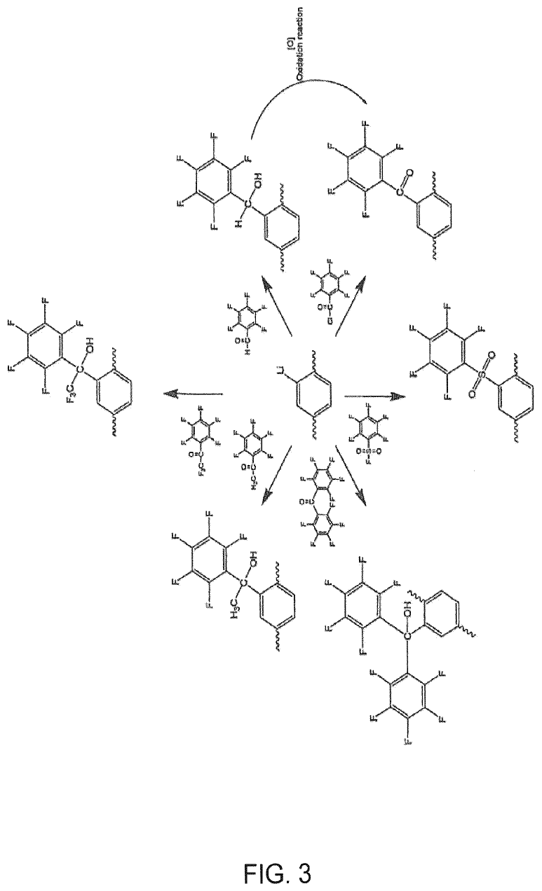

FIG. 3 reaction schemes for the modification of a lithiated polymer to provide a starting material according to a second embodiment;

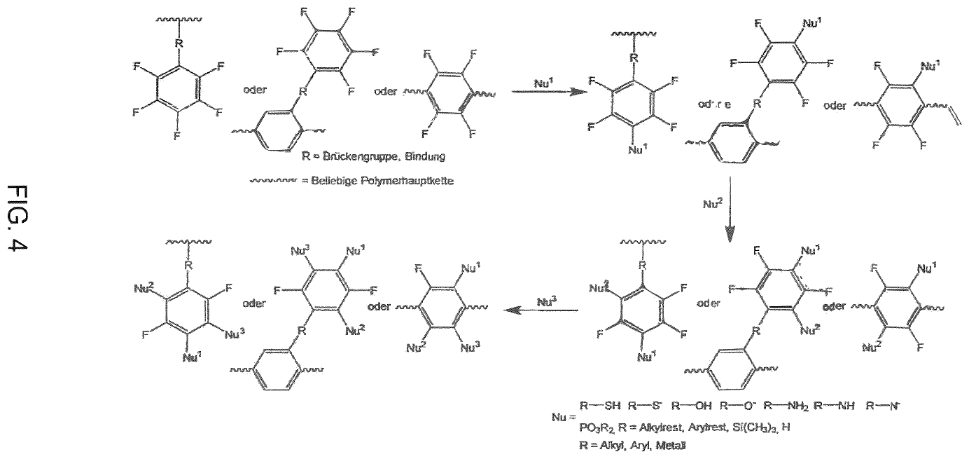

FIG. 4 a reaction scheme for the nucleophilic substitution of the starting material of FIG. 3;

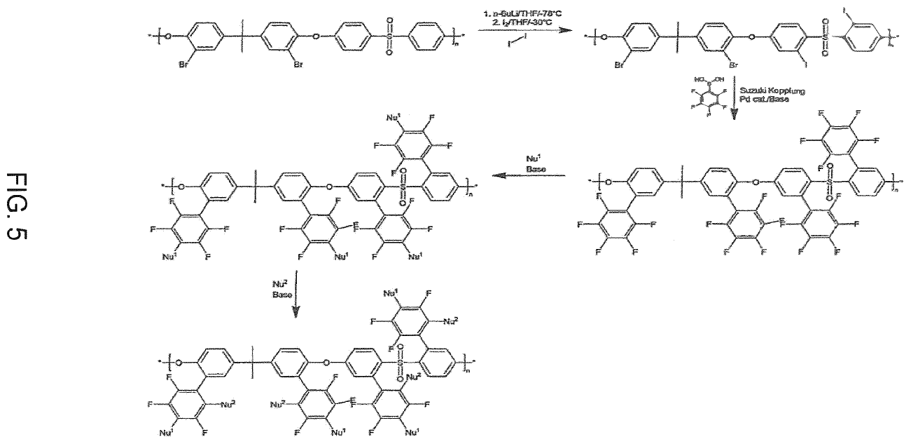

FIG. 5 a reaction scheme for nucleophilic substitution according to a third embodiment;

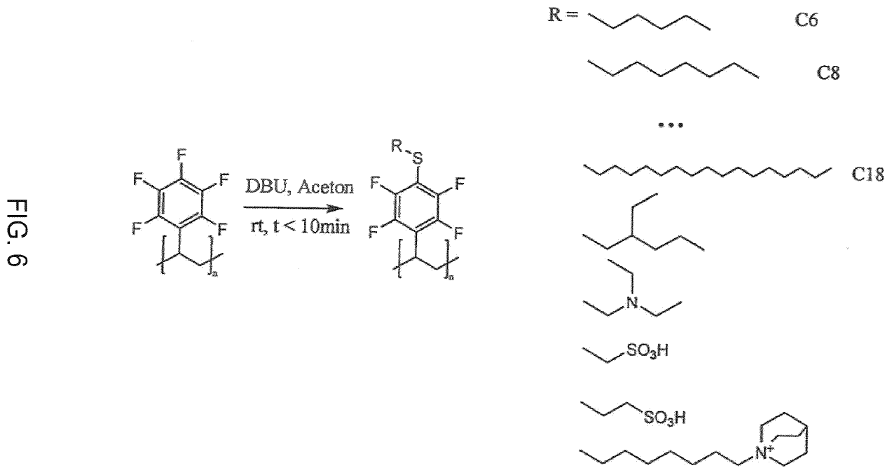

FIG. 6 a reaction scheme for nucleophilic substitution in a first step on polypentafluorostyrene according to a fourth embodiment;

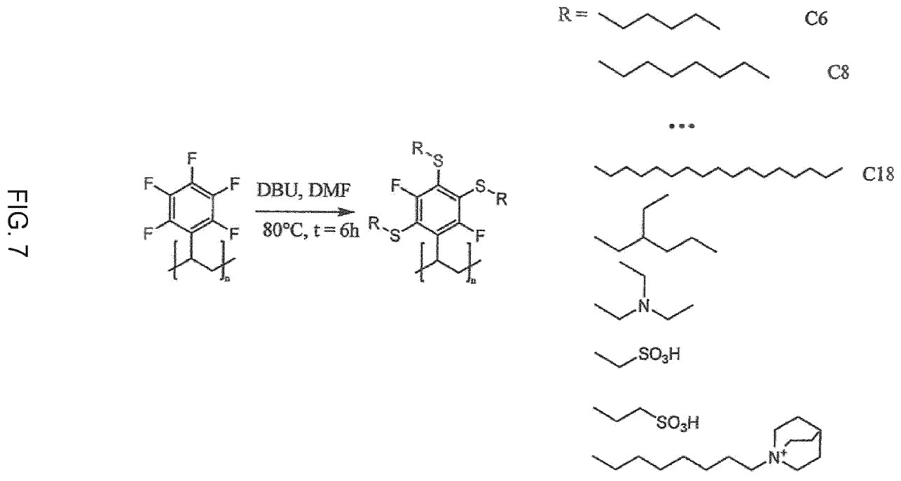

FIG. 7 a reaction scheme for the nucleophilic substitution of polypentafluorostyrene in a second step;

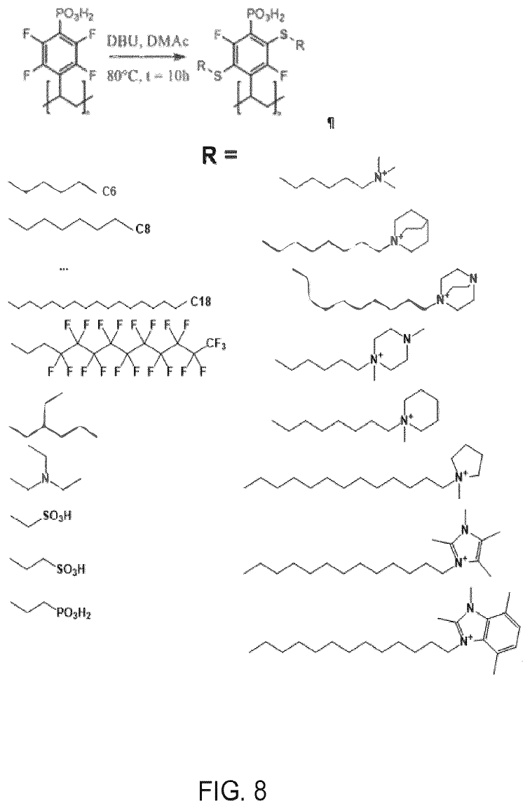

FIG. 8 a reaction scheme for the nucleophilic substitution of a polypentafluorostyrene already substituted in the para position in a second step;

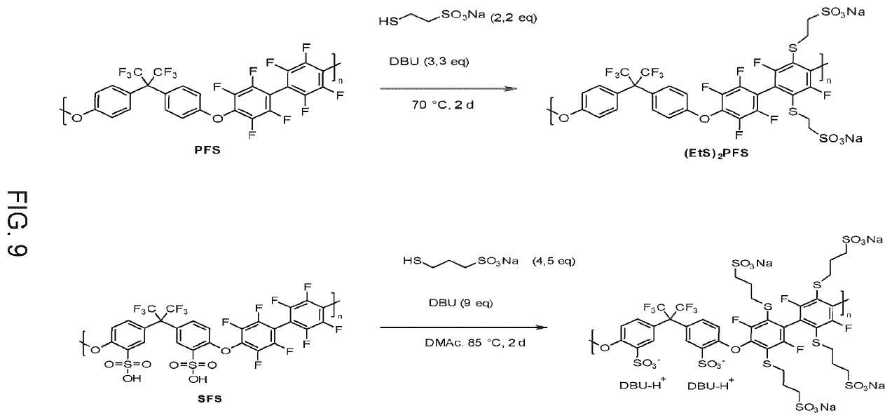

FIG. 9 a reaction schemes for the nucleophilic substitution of a partially or unsulfonated polymer according to a fifth embodiment;

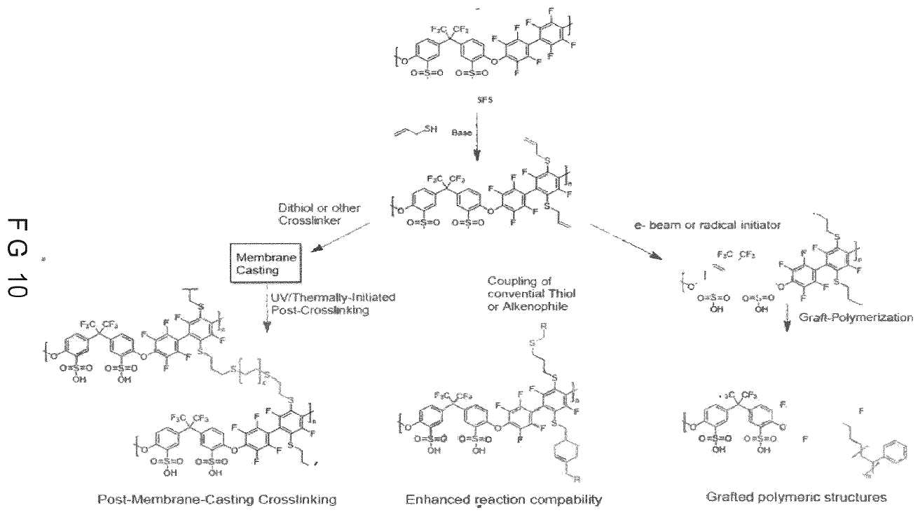

FIG. 10 a reaction scheme for the nucleophilic substitution of a perfluorinated biphenyl polymer using various processes;

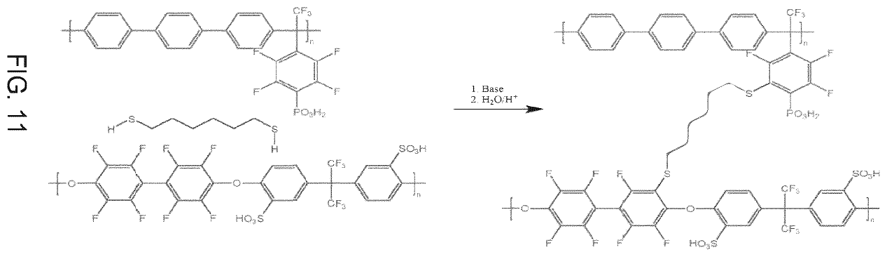

FIG. 11 a reaction scheme for the covalent crosslinking of aromatic sulfonated and/or phosphonated blend membranes of aromatic polymers according to a sixth embodiment;

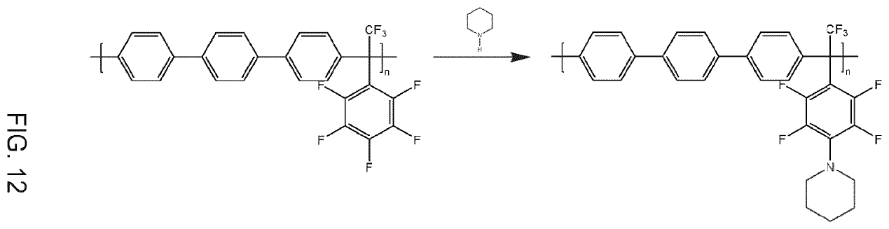

FIG. 12 a reaction scheme for reacting a polymer of p-terphenyl and perfluoroacetophenone with piperidine according to a seventh embodiment;

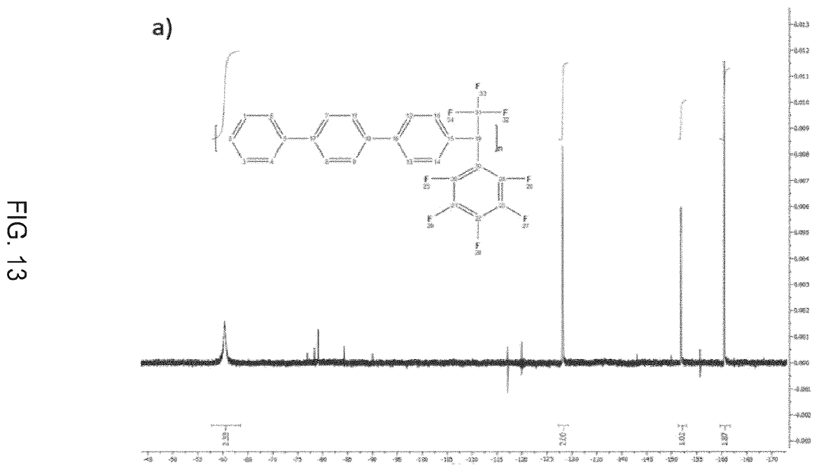

FIG. 13 NMR spectra of the polymer from FIG. 11 before and after and 14 the reaction with piperidine;

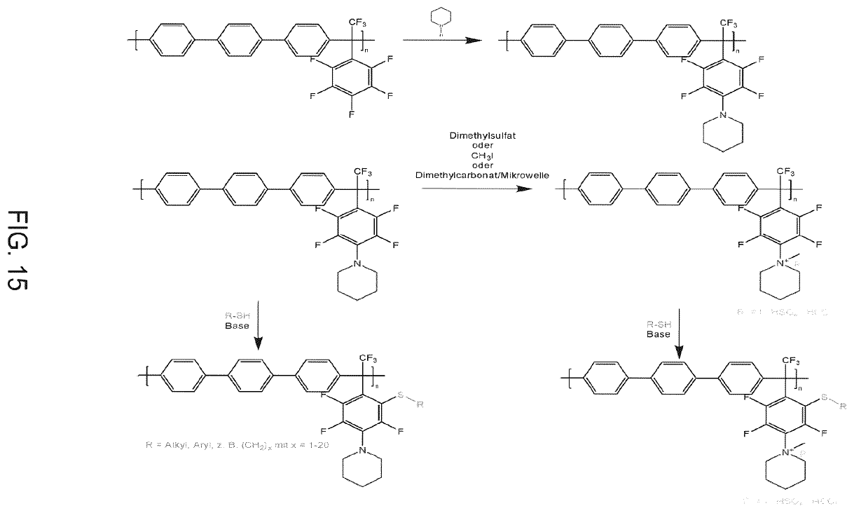

FIG. 15 reaction schemes of the nucleophilic substitution of the piperidine-modified polymer from FIG. 11;

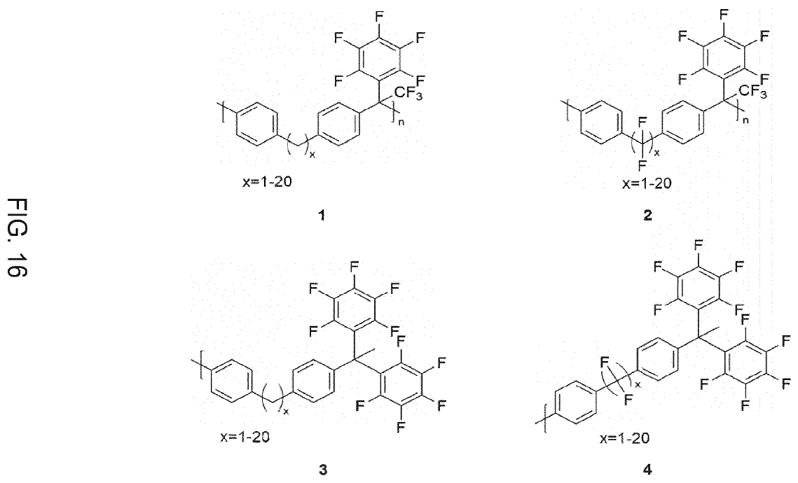

FIG. 16 a structural representation of various backbones modified by means of fluorinated and unfluorinated alkyl spacers, according to an eighth embodiment;

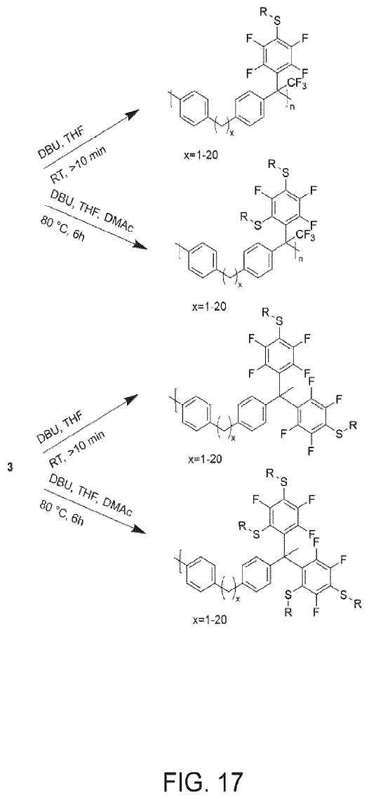

FIG. 17 reaction schemes for nucelophilic substitution of a polymer from FIG. 15;

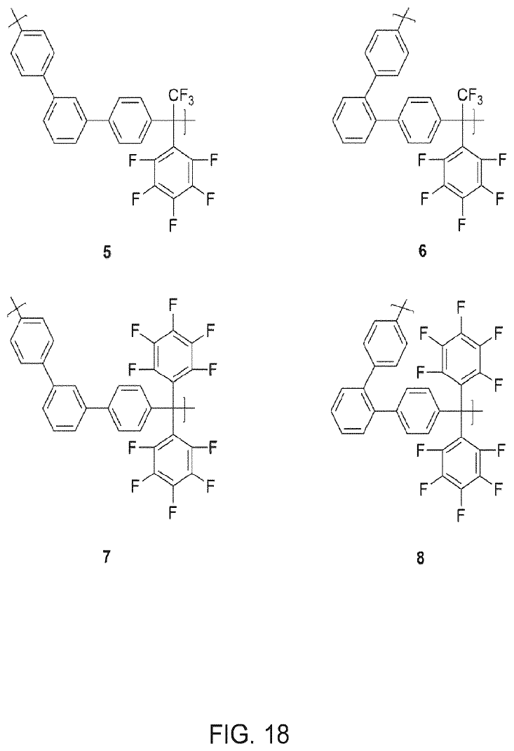

FIG. 18 a structural representation of terphenyl polymers from angled terphenyl monomers as starting materials;

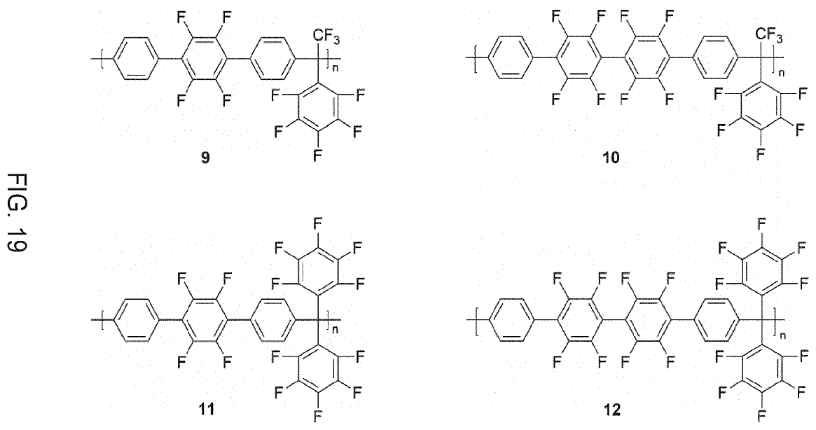

FIG. 19 a structural representation of main chains with partially fluorinated terphenyl/quarterphenyl units; and

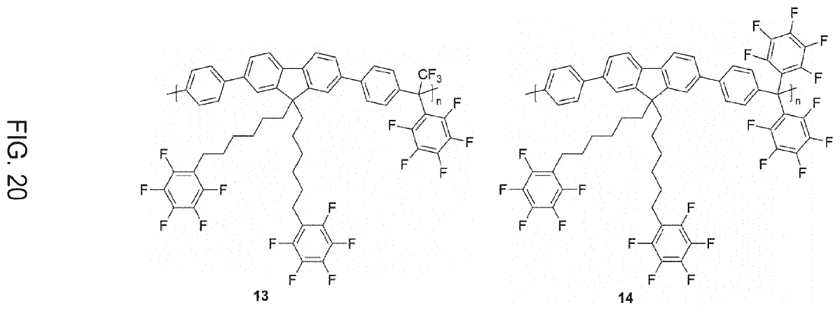

FIG. 20 a structural representation of fluorene-based backbones as starting materials.

### Design Example 1

FIGS. 1 and 2 show the reactions in the method according to the invention for producing a substance. The starting material, i.e. a polymer to be functionalized with an average molecular weight of about 100,000 g/mol, is obtained by polyhydroxyalkylation of p-terphenyl and perfluoroacetophenone. This starting material, which has perfluorophenyl units, is shown on the left in FIG. 2.

The preparation of a functional group, i.e. the preparation of a molecule for functionalization, is shown in detail in FIG. 1 and is carried out starting from dibromohexane. The functional group, which is shown at the bottom right in FIG. 1, has a halogen at one end and a cationic group at the other end.

Under the influence of a base, the para-fluorine atom and an ortho-fluorine atom are substituted by the functional group, as can be seen in the perfluorophenyl unit shown on the right in FIG. 2. The para-fluorine atom is substituted before the ortho-fluorine atom. A double ortho-substitution could not be observed in the NMR spectrum.

The substance produced by the reaction is transparent, colorless, flexible and has sufficient film-forming properties for the production of membranes.

### Design Example 2

The starting point for the second embodiment example are commercially available polymers, e.g. PSU Udel, PPSU Radel R (manufacturer Solvay) or Ultrason E, Ultrason P or Ultrason S (manufacturer BASF) or polyphenylene oxide (PPO)/polyphenylene ether (PPE). These are first lithiated, as shown in FIG. 3 on PSU Udel. Alkyl-lithium compounds, such as n-butylithium, are used for this purpose.

The substance is then reacted with reactive electrophiles such as acid chlorides, sulfonic acid fluorides, ketones, aldehydes or other electrophiles that contain perfluorinated aromatic groups. This process is illustrated in FIG. 3. The structures shown contain a perfluoroaromatic compound, in this case a perfluorophenyl unit. It has been shown that the perfluoroaromatic electrophiles do not react with the lithium atoms of the lithiated polymer with nucleophilic substitution of one or more of their fluorine atoms.

In a next step, the starting materials obtained in this way, in this case polymers containing perfluoroaromatic compounds, can be reacted with functional groups, for example. As in the first embodiment example, these can be thiols, which means that a sulphur atom takes the place of a fluorine atom.

It is also possible that, in a further step, the modified polymers react with tris-trimethylsilyl (phosphite) to obtain a phosphonated polymer. In a second step, this phosphonated polymer can be further reacted with a thiol, such as that described in embodiment 1.

Alternatively, substitution of the polymer with perfluoroaromatic compounds, which is shown in FIG. 3, would be possible with any functional group containing sulphur. Similarly, the further reaction can be carried out with any molecule containing, for example, a nitrogen atom or an oxygen atom.

It is initially envisaged that a first functional group (Nu1) will substitute a fluorine atom at the para position of the perfluoroaromatic compound. In a subsequent step, a second functional group will then substitute one of the two ortho-fluorine atoms (Nu2). Finally, in a third step, the meta-fluorine atom opposite the substituted ortho-fluorine atom can be substituted.

The nucleophilic substitution of at least two, in this case three, fluorine atoms takes place one after the other. This may involve the same functional group or different functional groups. The functional groups, i.e. the molecules used for substitution, which are also referred to as nucleophiles, can take the form of R—SH, R—S⁻, R—OH, R—NH, R—N⁻ or PO R₃₂, where R is an alkyl radical, aryl radical, alkyl, aryl, a metal, Si(CH) 33 or H. Any form of combination is conceivable. Specifically, the first nucleotide, i.e. the first functional group which substitutes the para-fluorine atom, can have the form R—SH, R—S⁻, R—OH, R—O⁻, R—NH₂, R—NH, R—N⁻, PO R₃₂. Completely independently of this, the second functional group, which is designated NU2, can comprise all forms. The same applies to a third functional group, which is designated Nu3.

The radical R may differ for the various functional groups. It is thus readily possible for the first functional group (Nu1) to have the form R—SH, where R is aryl, and for the second functional group (Nu2) to have the form R—OH, where R is a metal. Furthermore, the third functional group (Nu3) can readily have a further form, for example R—NH, where R is alkyl.

### Design Example 3

FIG. 5 shows a polymer according to the invention, for the production of which halogenated aromatic polymers were used as the base material. In the top left of FIG. 5, a halogenated polymer is shown which is substituted with bromine on the aromatic compound. In the first step, a Suzuki-C—C coupling is carried out using a perfluoroaromatic boronic acid. In this way, the polymer is provided with perfluoroaromatic compounds, in this case in the form of perfluorophenyl units.

In two further steps, first the para-fluorine atom and then an ortho-fluorine atom can be substituted by a functional group, i.e. a nucleophile. This takes place in each case under the influence of a base, whereby the nucleophile itself can also represent the base, as is the case, for example, when piperidine is used for the nucleophilic substitution of the fluorine atom.

Any functional groups can be used for nucleophilic substitution, in particular the functional groups which are explained in connection with embodiment example 1 and embodiment example 2, as well as embodiment example 4 described below.

### Design Example 4

FIGS. 6 and 7 show the reaction schemes with respect to a further embodiment according to the present invention.

First, a polymer to be functionalized is obtained by radical polymerization of pentafluorostyrene. The molar mass is variable between 8,000 and 300,000 g/mol. This starting material is shown schematically on the left in FIG. 6.

In a first step, a nucleophilic substitution of the para-fluorine atom of the pentafluorophenyl unit takes place. A degree of substitution of up to 100% can be achieved, based on the fluorine atoms in the para position. The molecules used for functionalization have a thiol group on a saturated hydrocarbon. This means that the sulphur atom of the thiol group takes the position of the substituted para-fluorine atom, as shown in FIG. 6. The possible radicals R are shown on the right in FIG. 6. Accordingly, the functional group may have a linear or branched Cₙ-body, for example a C₆-, a C₈-, a C₁₀-, C₁₂-, C₁₀-, C₁₂-, C₁₄-, C₁₆-, or a C₁₈-body. Furthermore, the functional group may contain a nitrogen atom or may have a quinuclidinium group or any other quaternary N group such as preferably ammonium, imidazolium, benzimidazolium, piperidinium, piperazinium, guanidinium, pyridinium or an acidic group such as SO₃ H or PO H₃₂ at the other end of the Cₙ-body facing away from the sulphur atom.

The substitution of the para-fluorine atom takes place at room temperature over a period of less than 10 minutes, in particular under the influence of triethylamine or triethanolamine or diazabicycloundecene (DBU, exact name 1,8-diazabicyclo [5.4.0]undec-7-ene) and/or acetone. In a second step, an ortho-fluorine atom is substituted. This second step is shown in detail in FIG. 7. For this purpose, the temperature is increased, in particular to a value above 60° C., preferably above 70° C., particularly preferably to a temperature of 80° C. The reaction time is about 6 hours. In this way, an ortho-fluorine atom and even a meta-fluorine atom are activated for nucleophilic substitution, as shown in FIG. 7.

FIG. 8 shows another reaction scheme. Here, the para-fluorine atom of a pentafluophenyl unit has already been substituted with a functional group in the first step. Specifically, the functional group is a phosphonic acid group. In a second step, the ortho-fluorine atom and the meta-fluorine atom are then substituted. The reaction time at a reaction temperature of 80° C. is about 10 hours, as shown in FIG. 8.

The functional groups that substitute the ortho-fluorine atom and the opposite meta-fluorine atom can be identical or different. The sulphur atom substituting the fluorine atom can be followed by a residue, an example of which is shown in FIG. 7. The different functional groups can be the same residue or different ones. Any combination of the radicals from FIGS. 6 and 7 is possible for the three functional groups provided.

It has been found that the material produced by the reaction described is transparent, colorless and flexible and has sufficient film-forming properties for the production of membranes.

### Design Example 5

In this embodiment, partially and unsulfonated polyethers are used as starting materials. Examples of starting materials are shown in FIG. 9 on the left. A thiol with a terminal sulfonate group is used as the molecule for the nucleophilic substitution. These are practically “clicked” to a perfluorinated biphenyl group by the aromatic substitution reaction described above. The ether bridges in the polymer backbone have a +M effect on the biphenyl group. This reduces the reactivity of the perfluoroaromatic compound compared to an aromatic nucleophilic substitution. Accordingly, the reaction temperature and reaction time are increased compared to the previously mentioned examples. In the reaction scheme shown in FIG. 9 above, in which PFS is used as the starting material, the substitution is intended to take place at a temperature of 70° C. over a period of, for example, 2 days. In the reaction scheme shown in FIG. 9 below, in which SFS is used as starting material, the reaction takes place at 85° over a period of, for example, 2 days, whereby a base is also used in comparison to the reaction scheme shown above. Both reactions preferably take place in the presence of DBU.

After the first substitution on one of the two rings of the perfluorobiphenyl unit, a second substitution occurs in the para position due to the activation of the opposite fluorine atom, as shown in FIG. 9. Due to this effect, almost exclusively perfluorinated phenyl rings without substitution or with a double substitution could be detected in the NMR spectrum, as shown above in FIG. 9, for example. The phenyl ring shown on the right is doubly substituted, while the adjacent phenyl ring of the perfluorobiphenyl unit on the left is not substituted. The counterions of the sulfonic acid groups can be exchanged by appropriate post-treatment with strong acids, so that the ionomer is converted into a corresponding ion exchange form.

An adaptation of the thiols used enables the coupling of a large number of functional groups to a fluorinated ionomer. These are then available for further reactions. Examples of such reactions are shown in FIG. 10. For example, the functionalization of a perfluorinated biphenyl polymer with alyl mercaptan is shown. The resulting double bond, which is formed in the first step, can be used for various subsequent reactions. For example, the functionalized polymer can be reacted with bifunctional crosslinkers, which react with the double bonds either thermally or photochemically activated after the creation of a polymer solution layer or membrane. Shown here, for example, is crosslinking with a dithiol via a thiol-(alk) ene click reaction (shown on the left in FIG. 10). Another reaction that can be carried out is coupling with simple thiols or other alkenophiles (for example in a Diels-Alder reaction). By introducing a thiol with alkyne functionality, other reactions such as copper-catalyzed alkyne-alkide couplings are also available. It is also possible to use the double bond as the starting point for graft polymerization, as shown in FIG. 10 on the right. This allows further polymer chains to be grafted onto the existing backbone. FIG. 10 shows unmodified styrene. For example, further acidic groups can be added by using functionalized monomers.

### Design Example 6

In this embodiment, the reaction scheme of which is shown in FIG. 11, a sulfonated partially fluorinated and a phosphonated partially fluorinated aromatic polymer are used as starting materials. In a first step, the individual components are dissolved in a solvent, preferably in a dipolar aprotic solvent such as NMP, DMAC, DMSO or DMF. In a further step, the two solutions are combined, whereby a dithiol crosslinker in the H form is added. The solvent is then evaporated in a convection oven at elevated temperatures of up to 150°.

During the evaporation of the solvent, a partial nucleophilic substitution of the thiol groups with a fluorine atom of the perfluoroaromatic compound already takes place.

After evaporation of the solvent, the membrane is treated in a strong alkaline solution, e.g. in NaOH, at an elevated temperature. This completes the cross-linking reaction, as the thiol anions are much more nucleophilic than the thiol groups in the H form. The crosslinking leads to the functional groups being coupled to two perfluoroaromatic compounds of two different oligomeric or polymeric chains. As a result, the two chains are crosslinked with each other, as shown in FIG. 11 on the right.

The functional group used here is a Cₙ-body, specifically a C₆-body, to the two ends of which a thiol group is attached. As can be seen in FIG. 11, one terminal sulphur atom substitutes a fluorine atom of a perfluoroaromatic compound and the other terminal sulphur atom of another perfluoroaromatic compound, which, however, belongs to a different chain.

### Design Example 7

A polymer of terphenyl and terfluoroacetophenone is selected as the starting material in the present case. This starting material is shown on the left in FIG. 12.

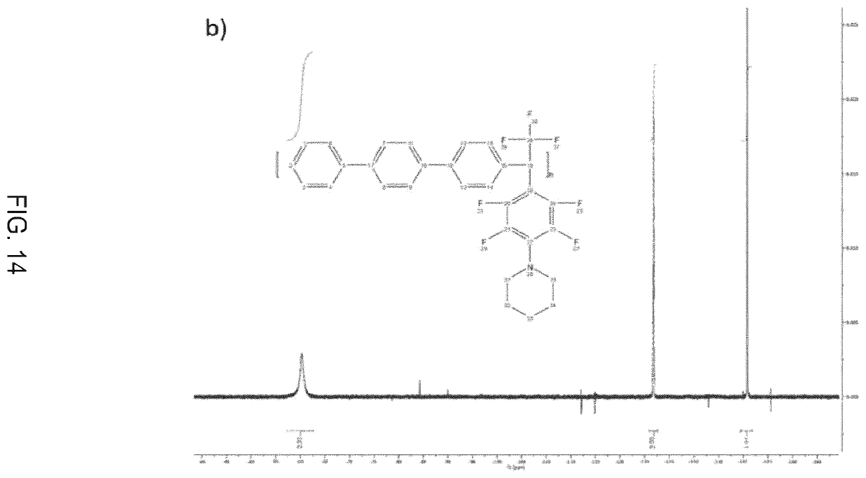

In a first step, the polymer is then reacted with piperidine, i.e. the para-fluorine atom is substituted accordingly. Surprisingly, this results in a 100% substitution of the para-fluorine atom with piperidine, which can be seen in the NMR spectra in FIG. 13 (unsubstituted polymer) and FIG. 14 with piperidine (substituted polymer).

The further modification reaction of the corresponding piperidine-substituted polymer is shown in FIG. 15. FIG. 15, bottom left, shows a further reaction with a thiol group. The functional group shown in the bottom left of FIG. 15 can be structured in the same way as the functional group of the first, third or fourth embodiment example, i.e. in particular in the form S—R, where R can be alkyl, aryl, e.g. (CH)₂ₓ with x=1-20.

Alternatively, after the first step (modification with piperidine), alkylation of the piperidine residue to the piperidinium cation can take place, as shown in FIG. 15 on the right. Thiolation can then take place again, as described above.

### Design Example 8

FIGS. 16 to 20 show various designs, in particular of backbones, some of which are provided with alkyl fluorinated and non-fluorinated spacers. The properties of the materials can be influenced by such spacers. Specifically, especially in the materials shown in FIG. 16, the flexibility of the chain segments is increased so that the membrane produced is less brittle than a system based purely on aromatic monomer units. Perfluorinated alkyl spacers can also be used, as shown in FIG. 16 in examples 2 and 4, for example, which improves the chemical stability of the materials.

FIG. 17 shows a nucleophilic substitution of fluorine atoms of the perfluorophenyl or perfluorobiphenyl unit of the two starting materials 1 and 3 from FIG. 16 in accordance with the invention. In each case, the para-fluorine atom and an ortho-fluorine atom of the corresponding units are substituted by a functional group in the form S—R. Similarly, the substitution can also be formed by functional groups in the form R—OH, R—NH, R—M⁻ or PO R₃₂, where R is an alkyl radical, aryl radical, alkyl, aryl, a metal, Si(CH) 33 or H. The radicals R may be the same functional group, particularly in the case of substitutions at the para position and at the ortho position. However, the functional groups can also differ in principle, which means that R stands for different residues.

In addition to the use of acylic spacers, the use of ortho- and meta-linked terphenyls is also possible. This is specifically shown in FIG. 18. Such linked terphenyls have a positive influence on the mechanical properties of the material. Terphenyl copolymers can also be synthesized which have both linear and angled terphenyl units in the chain, whereby the solubility of the polymers can be improved and their mechanical properties optimized by specifically selecting the mixing ratio between linear and angled terphenyl units.

The nucleophilic substitutions of the fluorine atoms described above can also be carried out on these compounds, as already described in connection with FIG. 17. Both singly and multiply substituted repeating units can be obtained in this way.

It is also possible to replace the terphenyl units with biphenyls or partially fluorinated aromatic systems, resulting in novel structures. Such structures can be seen in FIG. 19, for example.

By using the partially fluorinated aromatic units, it is possible to make further substitutions on various side chains on the fluorinated units of the backbone in addition to the substitutions on perfluorophenyl units already shown.

In addition, the aromatic portion of the backbone can also be represented by substituted fluorenes. Examples of such structures are shown in FIG. 20. The corresponding polymers can again be easily substituted according to the invention by means of a thiol click reaction. This means that fluorine atoms are substituted by corresponding thiol groups by means of a click reaction. This creates a further adjusting screw for influencing the number of side chains, which influences the properties of the resulting substance.

1-50. (canceled)

51. Substance, in particular functionalized oligomer or polymer, substance containing oligomeric or polymeric chains to which perfluoroaromatic compounds are coupled or which contain perfluoroaromatic compounds, wherein several, in particular two, three, four or five fluorine atoms of the perfluoroaromatic compound are each nucleophilically substituted by a functional group.

52. Substance according to claim 51, wherein the perfluoroaromatic compound is or comprises a perfluorophenyl and/or a perfluorobiphenyl unit, wherein, in particular, the para and at least one ortho position and/or at least one meta position of the perfluorophenyl unit or the perfluorobiphenyl unit is each substituted by a functional group, and/or
wherein the perfluoroaromatic compound is contained in the main and/or side chain of the oligomeric or polymeric chain or forms a side chain, and/or
wherein the oligomeric or polymeric chains contain cation exchanger and/or anion exchanger groups, and/or
wherein the oligomeric or polymeric chains contain a repeating unit comprising or consisting of pentafluorostyrene, and/or
wherein the plurality of fluorine atoms of the perfluoroaromatic compound are substituted with the same functional group or with different functional groups.

53. Substance according to claim 51, wherein a functional group is coupled to the perfluoroaromatic compound in such a way that a fluorine atom is substituted by a sulfur atom.

54. Substance according to claim 53, wherein the functional group comprises a linear and/or branched saturated or unsaturated Cₙ body, in particular a C₂, C₃, C₆, C₈, C₁₀, C₁₂, C₁₄, C₁₆ or a Cis body carrying at one end the sulphur atom substituting a fluorine atom of the perfluoroaromatic compound.

55. Substance according to claim 54, wherein a quinuclidinium group or another quaternary N group, in particular an ammonium, imidazolium, benzimidazolium, piperidinium, piperazinium, guanidinium or pyridinium group, preferably with counterions, is present at the other end of the Cₙ body, in particular with a bis(trifluoromethylsulfonyl)amide anion or a mineral acid anion, in particular a halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃, phosphonate R—PO H₃″, carbonate CO₃²⁻, HCO₃⁻ or with an organic carboxylic acid anion, in particular CH₃ COO⁻, HCOO⁻.

56. Substance according to claim 53, wherein the functional group contains a nitrogen atom as a primary, secondary, tertiary or quaternary amine or ammonium group.

57. Substance according to claim 51, wherein a functional group is formed in the form R—SH, R—S⁻, R—OH, R—NH, R—N⁻ or PO R₃₂, where R is alkyl, aryl, alkyl, aryl, a metal, Si(CH)₃₃ or H, and/or
wherein a functional group contains a thiol group or is based on a thiol group or has been prepared starting from a thiol group, and/or
wherein a functional group SO contains₃ with a counter cation, in particular with a metal counter cation or an ammonium counter cation in the form NR₄⁺ with R═H, alkyl, aryl or with another N-basic cation, in particular imidazolium, benzimidazolium, guanidinium, which is coupled with a sulphur atom substituting a fluorine atom, and/or wherein a functional group C contains NH₅₁₀ wherein the nitrogen atom substitutes the fluorine atom of the perfluoroaromatic compound, wherein, in particular, a radical is coupled in particular via the nitrogen atom, the radical preferably being a halide (F⁻, Cl⁻, Br⁻, I⁻) or SO₄²⁻, HSO₄⁻, PO₄³⁻, HPO₄²⁻, H₂ PO₄⁻, SO₃²⁻, SO H₃, phosphonate R—PO H₃⁻, carbonate CO₃²⁻, HCO₃ or an organic carboxylic acid anion, in particular CH₃ COO⁻, HCOO⁻, and/or
wherein the functional group is coupled to several, in particular to two perfluoroaromatic compounds of two different oligomeric or polymeric chains, so that the functional group cross-links the chains, wherein, in particular, the functional group is chain-like and has a sulfur atom at each end which nucleophilically substitutes a fluorine atom of the perfluoroaromatic compounds and preferably
comprises one or more Cₙ-bodies and/or a repeating unit.

58. A membrane, in particular a diaphragm, which comprise a substance according to claim 51, and, in particular, is ion exchange membrane, preferably a cation exchange membrane or an anion exchange membrane.

59. Use of a membrane according to claim 58 in an electrochemical plant, in particular in a fuel cell or a battery, or in an electrochemical methods, in particular in an electrolysis method or in an electrosynthesis method.

60. Method for preparing a substance, comprising the following steps:
providing a starting material which contains oligomeric or polymeric chains to which perfluoroaromatic compounds with several fluorine atoms are coupled or which contain perfluoroaromatic compounds with several fluorine atoms;
nucleophilic substitution of at least two, in particular of exactly two, three, four or five fluorine atoms of the perfluoroaromatic compound by one functional group in each case.

61. Method according to claim 60, wherein the perfluoroaromatic compound of the starting material is or comprises a perfluorophenyl or a perfluorobiphenyl unit, wherein, in particular, the para and at least one ortho position and/or at least one meta position of the perfluorophenyl unit or the perfluorobiphenyl unit is substituted by a functional group, and/or
wherein the starting material is prepared by the polyhydroxyalkylation of p-terphenyl and perflouroacetophenone, and/or
wherein the starting material is prepared by a polymerization of pentafluorostyrene, in particular with a molar mass of 8,000 to 300,000 g/mol, and/or
wherein the starting material is a partially fluorinated polyether or polythioether or polysulfone, and/or
wherein the starting material is a sulfonated partially fluorinated or a phosphonated partially fluorinated polymer, and/or
wherein the starting material is a polymer of terphenyl or quaterphenyl and/or perfluoroacetophenone and/or of another partially fluorinated and/or partially aromatic ketone, and/or
wherein the starting material contains fluorinated and/or unfluorinated alkane spacers in the oligomeric or polymeric chains, and/or
wherein the starting material is a terphenyl polymer, in particular of angled terphenyl monomers and/or quaterphenyl monomers, and/or in that the chains of the starting material contain partially fluorinated terphenyl and/or quaterphenyl units, and/or
wherein the starting material contains fluorene-based backbones, and/or
wherein the starting material is prepared by coupling perfluoroaromatic compounds to a base material, in particular to a polymer, wherein, in particular, the base substance is a halogenated, aromatic polymer which is substituted on the aromatic compound in particular with I, Br and/or Cl, and, preferably, the perfluoroaromatic compound is coupled to the base substance by Suzuki-C—C coupling, in particular under the action of a partially fluoroaromatic and/or perfluoroaromatic boronic acid, and/or
wherein the nucleophilic substitution of a plurality of fluorine atoms is carried out in one step, wherein, in particular, the nucleophilic substitution takes place under the action of a base, and/or
wherein the nucleophilic substitution of a plurality of fluorine atoms takes place in a plurality of successive steps, and/or
wherein a molecule C NH₅₁₀ is used for the substitution, the nitrogen atom substituting the fluorine atom of the perfluoroaromatic compound, wherein, in particular, a radical is coupled in particular via the nitrogen atom, the radical preferably being a halide (F⁻, Cl⁻, Br⁻, I⁻) or SO₄²⁻, HSO₄⁻, PO₄³⁻, HIPO₄²⁻, H₂ PO₄⁻, SO₃²⁻, SO H₃⁻, phosphonate R—PO H₃⁻, carbonate CO₃²⁻, HCO₃ or an organic carboxylic acid anion, in particular CH₃ COO⁻, HCOO⁻, and/or
wherein the functional group is coupled to several, in particular to two perfluoroaromatic compounds of two different oligomeric or polymeric chains, so that the functional group cross-links the chains with one another, wherein, in particular, the functional group is chain-like and has at each end a sulfur atom which nucleophilically substitutes a fluorine atom of the perfluoroaromatic compounds, and preferably comprises one or more Cₙ-bodies and/or a repeating unit, and/or
wherein, following the nucleophilic substitution, subsequent reactions take place for which the functional groups form a reaction basis.
